(19) United States
(12) Patent Application Publication
(10) Pub. No.: US 2002/0191554 A1
(43) Pub. Date: Dec. 19, 2002

(54) Mobile station position detection scheme

(75) Inventor: Takayuki Kondo, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/166,771

(22) Filed: Jun. 12, 2002

(30) Foreign Application Priority Data
Jun. 18, 2001 (JP) 2001-183750
Apr. 12, 2002 (JP) 2002-110506

(51) Int. Cl. H04Q 7/00; H04Q 7/20

(52) U.S. Cl. 370/328; 370/338; 455/456; 455/522

(57) ABSTRACT

A mobile station position detection scheme comprising a mobile communication control apparatus which obtains the position of a mobile station from the radio propagation times and position information, a mobile station which receives a position detection instruction signal through each of a plurality of radio base stations and a notification signal sent from each radio base station, extracts three radio base stations in descending order of reception level, and sends a position detection signal to the three radio base stations using a reverse common channel, and a plurality of radio base stations each of which receives the position detection signal, obtains a radio propagation time from the radio base station to the mobile station on the basis of the sending time of the latest notification signal, the reception time of the received position detection signal, and a processing time in the mobile station, and transmits the radio propagation time to a mobile station position detection apparatus. The position of the mobile station is obtained using the mobile station position detection apparatus from three radio propagation times and position information from three radio base stations.

### BACKGROUND OF THE INVENTION

1. Field of the Invention

The present invention relates to a mobile station position detection scheme and, more particularly, to a mobile station position detection scheme for detecting the position of a mobile station on the basis of a radio propagation time between the mobile station and a plurality of radio base stations and position information from these radio base stations.

2. Description of the Prior Art

Conventionally, a mobile station position detection scheme of this type is used to detect the position of a mobile station.

FIG. 1 is a block diagram for explaining the conventional mobile station position detection scheme. Referring to FIG. 1, the conventional mobile station position detection scheme has a mobile station 6, a plurality of radio base stations 7, a mobile communication network control apparatus 8, a position registration server 5, and a mobile station position detection apparatus 9. The position of the mobile station 6 is detected by operations (1) to (11) shown in FIG. 2.

(1) When the mobile station 6 is powered on or moves to the area of another radio base station 7, a position registration signal is sent from the mobile station 6 to the closest radio base station 7 using a reverse common channel (random access channel). The position registration signal is relayed by the radio base station 7 and sent to the position registration server 5 through the mobile communication network control apparatus 8. Upon receiving the position registration signal, the position registration server 5 registers a mobile station ID and area code added to the position registration signal, and a radio base station ID. The position registration server 5 manages the radio base station ID and mobile station ID for each area code.

(2) The mobile communication network control apparatus 8 receives a position detection request signal (with the ID of the mobile station 6 to be detected) for requesting position detection of the mobile station 6. On the basis of information registered in the position registration server 5, the mobile communication network control apparatus 8 sends a call signal to the mobile station 6 whose position is to be detected, through each radio base station 7 that is present in the position registration area. A paging channel is used for this transmission.

(3) Upon receiving the call signal, the mobile station 6 sends a reply signal to the mobile communication network control apparatus 8 through the closest radio base station 7 using a reverse common channel (random access channel).

(4) The mobile communication network control apparatus 8 requests, using a forward common channel (forward access channel) through the radio base station 7 through which the reply signal from the mobile station 6 is received, the mobile station 6 to “receive a notification signal (broadcast channel) transmitted from each radio base station 7 near the mobile station 6 and measure the signal level of each notification signal”.

(5) Upon receiving a notification signal (broadcast channel) transmitted from each radio base station 7 near the mobile station 6, the mobile station 6 measures the signal level of each notification signal and sends, to the mobile communication network control apparatus 8 through the closest radio base station 7 using a reverse common channel (random access channel), information representing radio base stations 7 which have high reception levels equal to or more than a predetermined level. At this time, the number of radio base stations 7 with high reception levels is 3 or more at a probability of about ⅓, 2 at a probability of about ⅓, and 1 at a probability of about ⅓, though it changes depending on the geographical features and the density of base stations. Since one radio base station 7 suffices for communication, the “predetermined level” is so set as to obtain the notification signal from one radio base station 7.

(6) The mobile communication network control apparatus 8 sends, to the mobile station 6 through the closest radio base station 7 using a forward common channel (forward access channel), “information necessary for communicating with the plurality of radio base stations 7 whose reception levels of notification signals (broadcast channels) transmitted from the radio base stations 7 near the mobile station 6 are high by using individual communication channels (dedicated channels)”. The mobile station 6 sends the capability information (indicating ACK) of the mobile station 6 to the mobile communication network control apparatus 8 through the closest radio base station 7 using a reverse common channel (random access channel).

(7) Between the mobile communication network control apparatus 8 and the mobile station 6, a communication state in which communication is possible is set using individual communication channels (dedicated channels) and the plurality of radio base stations 7 whose reception levels of notification signals (broadcast channels) transmitted from the radio base stations 7 near the mobile station 6 are high. When a communication state with the mobile station 6 is set, the mobile communication network control apparatus 8 registers the state of the mobile station 6 as the communication state in the position registration server 5. When the mobile communication network control apparatus 8 and mobile station 6 cease to be in the communication state, the mobile communication network control apparatus 8 cancels the communication state.

(8) In this communication state, the mobile communication network is requested to detect the position of the mobile station 6. When the mobile communication network control apparatus 8 receives a position detection instruction signal which requests the position of the mobile station 6, the position detection instruction signal is supplied to the plurality of radio base stations 7 which are in the communication state with the mobile station 6.

(9) Each of the plurality of radio base stations 7 in the communication -state with the mobile station 6 obtains a radio propagation time from the transmission timing of a signal A using a forward individual communication channel (dedicated channel), the reception timing of a signal B sent from the mobile station 6 using a reverse individual communication channel (dedicated channel) in correspondence with the signal A, and a processing time between reception of the signal A and sending of the signal B by the mobile station 6, which is measured and defined in advance.

(10) Each of the plurality of radio base stations 7 in the communication state with the mobile station 6 sends the radio propagation time to the mobile station position detection apparatus 9 through the mobile communication network control apparatus 8.

(11) The mobile station position detection apparatus 9 calculates the position of the mobile station 6 on the basis of the radio propagation time between the mobile station 6 and each of the plurality of radio base stations 7 and pieces of position information of the plurality of radio base stations 7, which are stored in advance.

In the above-described conventional mobile station position detection scheme, as indicated by (7) to (11), (7) between the mobile communication network control apparatus and the mobile station, the communication state in which communication is possible is ensured using an individual communication channel (dedicated channel) and through a plurality of radio base stations whose reception levels of notification signals (broadcast channels) transmitted from the radio base stations near the mobile station are high. (8) In this communication state, the mobile communication network is requested to detect the position of the mobile station. When the mobile communication network control apparatus receives a position detection instruction signal which requests the position of the mobile station, the position detection instruction signal is supplied to the plurality of radio base stations which communicate with the mobile station. (9) Each of the plurality of radio base stations which communicate with the mobile station obtains a radio propagation time from the transmission timing of the signal A using a forward individual communication channel (dedicated channel), the reception timing of the signal B sent from the mobile station using a reverse individual communication channel (dedicated channel) in correspondence with the signal A, and the processing time between reception of the signal A and sending of the signal B by the mobile station, which is measured and defined in advance. (10) Each of the plurality of radio base stations which communicate with the mobile station sends the radio propagation time to the mobile station position detection apparatus of the mobile communication network control apparatus. (11) The mobile station position detection apparatus calculates the position of the mobile station on the basis of the radio propagation time between the mobile station and each of the plurality of radio base stations and pieces of position information of the plurality of radio base stations, which are stored in advance. As indicated by (9), each of the plurality of radio base stations which communicate with the mobile station obtains the radio propagation time from the transmission timing of the signal A using a forward individual communication channel (dedicated channel), the reception timing of the signal B sent from the mobile station using a reverse individual communication channel (dedicated channel) in correspondence with the signal A, and the processing time between reception of the signal A and sending of the signal B by the mobile station, which is measured and defined in advance. For this reason, the radio propagation time cannot be obtained unless transmission/reception using an individual communication channel (dedicated channel) is in progress, i.e., it can be obtained only when the communication state is set between the mobile communication network control apparatus and the mobile station using an individual communication channel (dedicated channel) with a base station.

In addition, as indicated by (5) to (7), (5) upon receiving a notification signal (broadcast channel) transmitted from each radio base station near the mobile station, the mobile station measures the signal level of each notification signal and sends, to the mobile communication network control apparatus through the closest radio base station using a reverse common channel (random access channel), information representing radio base stations which have high reception levels equal to or more than a predetermined level (at this time, the number of radio base stations with high reception levels is 3 or more at a probability of about ⅓, 2 at a probability of about ⅓, and 1 at a probability of about ⅓, though it changes depending on the geographical features and the density of base stations). (6) The mobile communication network control apparatus sends, to the mobile station through the closest base station using a forward common channel (forward access channel), “information necessary for communicating with the plurality of radio base stations whose reception levels of notification signals (broadcast channels) transmitted from the radio base stations near the mobile station are high by using individual communication channels (dedicated channels)”. The mobile station sends the capability information (indicating ACK) of the mobile station to the mobile communication network control apparatus through the closest base station using a reverse common channel (random access channel). (7) Between the mobile communication network control apparatus and the mobile station, a communication state in which communication is possible is ensured using individual communication channels (dedicated channels) and through the plurality of radio base stations whose reception levels of notification signals (broadcast channels) transmitted from the radio base stations near the mobile station are high. Since the number of radio base stations with high reception levels equal to or more than a predetermined level is 3 or more at a probability of about ⅓, only one or two radio base stations can be detected at a probability of ⅔. Hence, position detection of the mobile station can be executed at a probability of only ⅔.

### SUMMARY OF THE INVENTION

The present invention has been made in consideration of the above situation, and has as its object to provide a mobile station position detection scheme capable of obtaining a radio propagation time even when no communication state is set between a mobile communication network control apparatus and a mobile station and also always accurately detecting the position of a mobile station.

In order to achieve the above object, according to the first main aspect of the present invention, there is provided a mobile station position detection scheme for detecting a position of a mobile station on the basis of radio propagation times between the mobile station and a plurality of radio base stations and pieces of position information from the radio base stations, characterized by comprising:

mobile communication network control means for receiving a position detection request signal which requests position detection of the mobile station, when the mobile station is not in a communication state, sending a position detection instruction signal which instructs position detection of the mobile station to radio base stations that cover an area where the mobile station is present, receiving a radio propagation time between the mobile station and each radio base station from each of a predetermined number of radio base stations in correspondence with the position detection instruction signal, and obtaining the position of the mobile station on the basis of the radio propagation times and pieces of position information from the plurality of radio base stations corresponding to the radio propagation times;

the plurality of radio base stations each of which periodically sends a notification signal as information necessary for the mobile station to do communication in the area covered by the radio base station, upon receiving the position detection instruction signal from the mobile communication network control means, transmits the position detection instruction signal to the mobile station designated by the position detection instruction signal, upon receiving a position detection signal used for position detection through a reverse common channel and if the received position detection signal is targeted to the radio base station, obtains the radio propagation time from the radio base station to the mobile station on the basis of a sending time of a latest notification signal, a reception time of the received position detection signal, and a predetermined processing time in the mobile station, and transmits the radio propagation time to the mobile communication network control means; and

the mobile station which receives the position detection instruction signal from each of the radio base stations, after reception, receives the notification signal sent from each of the plurality of radio base stations, extracts the predetermined number of radio base stations in descending order of reception signal power level, and transmits the position detection signal to the radio base stations through corresponding reverse common channels.

The mobile station in the above first main aspect can receive the position detection instruction signal from each of the radio base stations, then receive the notification signal sent from each of the plurality of radio base stations, and extract at least three radio base stations in descending order of reception signal power level.

The mobile communication network control means in the above first main aspect can draw three circles which have centers at three positions indicated by the position information from the radio base stations corresponding to three of the radio propagation times received from the predetermined number of radio base stations and use, as radii, distances obtained on the basis of the radio propagation times corresponding to the radio base stations, and obtain the position of the mobile station from an intersection relationship between the three circles.

In order to achieve the above object, according to the second main aspect of the present invention, there is provided a mobile station position detection scheme for detecting a position of a mobile station on the basis of radio propagation times between the mobile station and a plurality of radio base stations and pieces of position information from the radio base stations, characterized by comprising:

a mobile communication network control apparatus which receives a position detection request signal which requests position detection of the mobile station, checks whether the mobile station is in a communication state, when the mobile station is not in the communication state, sends a position detection instruction signal which instructs position detection of the mobile station to radio base stations that cover an area where the mobile station is present, receives a radio propagation time between the mobile station and each radio base station from each of a predetermined number of radio base stations in correspondence with the position detection instruction signal, and outputs the radio propagation times;

a mobile station position detection apparatus which receives the radio propagation times output from the mobile communication network control apparatus, searches for and acquires pieces of position information of the radio base stations corresponding to the radio propagation times, and obtains the position of the mobile station from the pieces of position information and the radio propagation times received from the mobile communication network control apparatus;

the plurality of radio base stations each of which periodically sends a notification signal as information necessary for the mobile station to do communication in the area covered by the radio base station, upon receiving the position detection instruction signal from the mobile communication network control apparatus, transmits the position detection instruction signal to the mobile station designated by the position detection instruction signal, upon receiving a position detection signal used for position detection through a reverse common channel and if the received position detection signal is targeted to the radio base station, obtains the radio propagation time from the radio base station to the mobile station on the basis of a sending time of a latest notification signal, a reception time of the received position detection signal, and a predetermined processing time in the mobile station, and transmits the radio propagation time to the mobile communication network control apparatus; and

the mobile station which receives the position detection instruction signal from each of the radio base stations, after reception, receives the notification signal sent from each of the plurality of radio base stations, extracts the predetermined number of radio base stations in descending order of reception signal power level, and transmits the position detection signal to the radio base stations through corresponding reverse common channels.

The second mobile station position detection scheme further comprises a position registration server which registers whether the mobile station is in the communication state, and the mobile communication network control apparatus can receive the position detection request signal which requests position detection of the mobile station and check by the position registration server whether the mobile station is in the communication state.

The mobile station in the second aspect receives the position detection instruction signal from each of the radio base stations, then receives the notification signal sent from each of the plurality of radio base stations, and extracts at least three radio base stations in descending order of reception signal power level.

The mobile station position detection apparatus in the second aspect draws three circles which have centers at three positions indicated by the position information from the radio base stations corresponding to three of the radio propagation times received from the mobile communication network control apparatus and use, as radii, distances obtained on the basis of the radio propagation times corresponding to the radio base stations, and obtains the position of the mobile station from an intersection relationship between the three circles.

The radio base station in the first and second aspects subtracts a predetermined processing time in the mobile station from a difference between the sending time of the latest notification signal and the reception time of the position detection signal and divides a thus obtained time by 2 to obtain the radio propagation time from each of the plurality of radio base stations to the mobile station.

As is apparent from the above aspects, according to the mobile station position detection scheme of the present invention, the position detection signal is transmitted from the mobile station to the predetermined number of radio base stations through the reverse common channels (random access channels). The position detection signal is received by the plurality of radio base stations through the reverse common channels (random access channels). The radio propagation time from each radio base station to the mobile station is obtained on the basis of the sending time of the latest notification signal, the reception time of the received position detection signal, and the predetermined time in the mobile station. The radio propagation time is obtained by the signal transmitted through the reverse common channel (random access channel) without using any individual communication channel (dedicated channel). For this reason, even when no communication state is set between the mobile communication network control apparatus and the mobile station, the radio propagation time can be obtained.

In addition, the mobile communication network control apparatus can receive, e.g., three radio propagation times and obtain the position of the mobile station on the basis of these radio propagation times and the position information of radio base stations corresponding to the radio propagation times. For this reason, the position of the mobile station can always be accurately detected.

The above and many other objects, features and advantages of the present invention will become manifest to those skilled in the art upon making reference to the following detailed description and accompanying drawings in which preferred embodiments incorporating the principle of the invention are shown by way of illustrative examples.

### BRIEF DESCRIPTION OF THE DRAWINGS

FIG. 1 is a block diagram showing the arrangement of a conventional mobile station position detection scheme;

FIG. 2 is a timing chart showing the operation procedure of the conventional mobile station position detection scheme shown in FIG. 1;

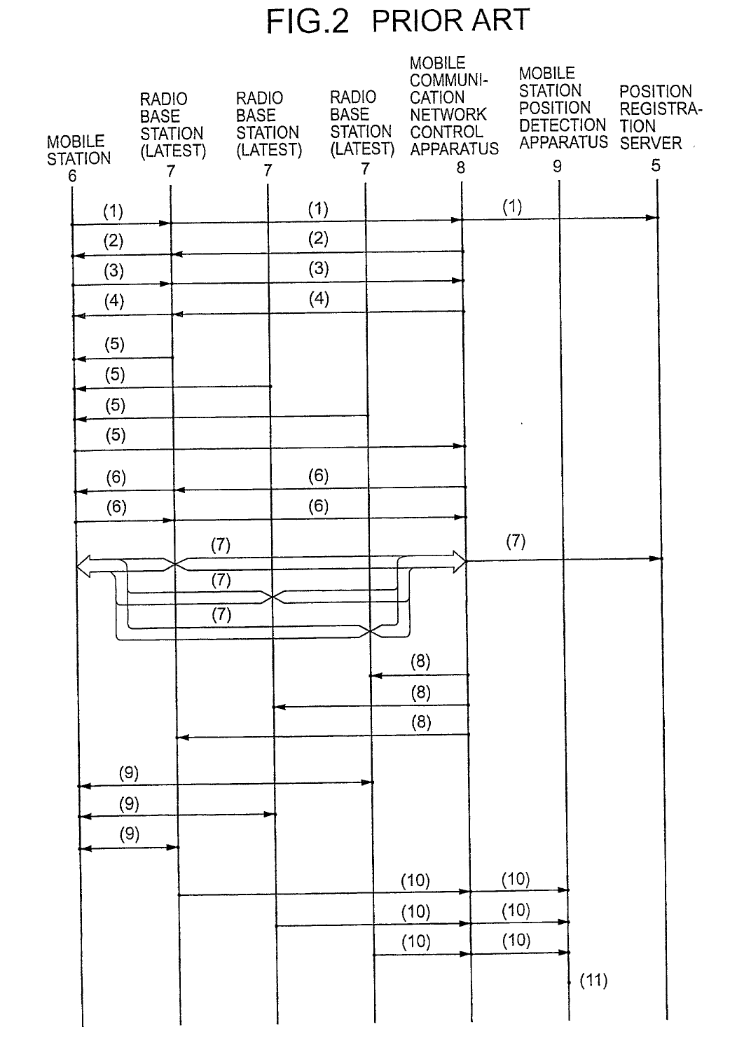

FIG. 3 is a block diagram showing the arrangement of an embodiment of the present invention;

FIG. 4 is a timing chart for explaining the operation procedure of the embodiment of the present invention shown in FIG. 3;

FIG. 5 is a view showing a method of obtaining a radio propagation time between a mobile station and a radio base station; and

FIG. 6 is a view showing an example in which the position of a mobile station is obtained using three circles.

### DETAILED DESCRIPTION OF THE PREFERRED EMBODIMENTS

A preferred embodiment of the present invention will be described below with reference to the accompanying drawings.

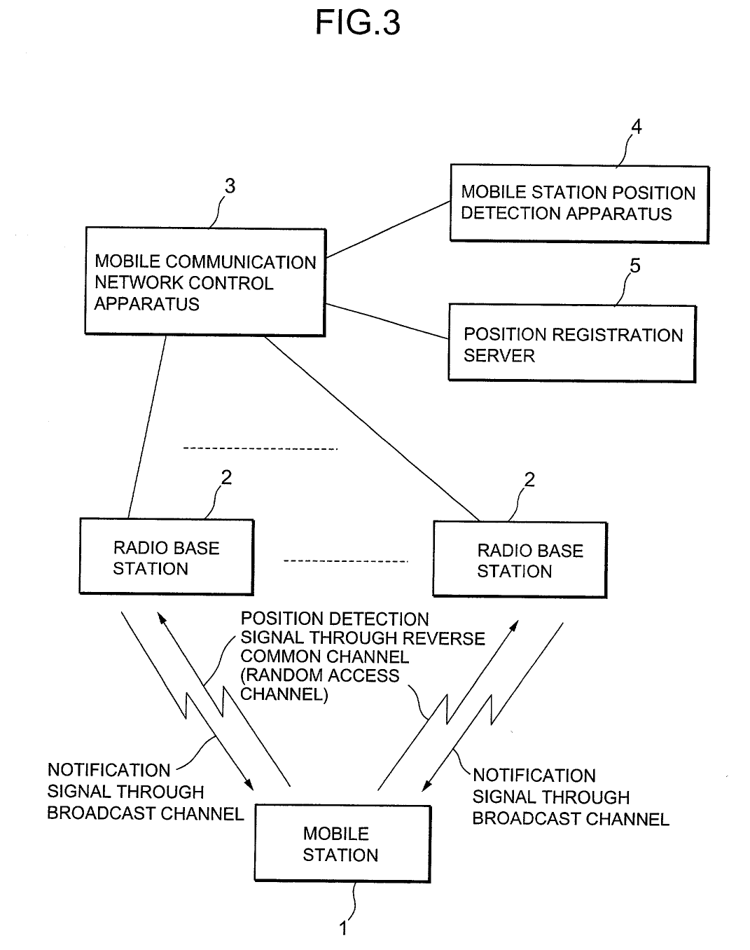

FIG. 3 shows a mobile station position detection scheme according to an embodiment of the present invention. As is apparent from FIG. 3, this embodiment comprises a mobile station 1, a plurality of radio base stations 2, a mobile communication network control apparatus 3, a mobile station position detection apparatus 4, and a position registration server 5.

The mobile communication network control apparatus 3 receives a position detection request signal which requests position detection of the mobile station 1, and checks whether the mobile station 1 is in a communication state. If the mobile station 1 is not in the communication state, the mobile communication network control apparatus 3 sends a position detection instruction signal which instructs position detection of the mobile station 1 to the radio base stations 2 which cover the area where the mobile station 1 is present. In correspondence with this position detection instruction signal, the mobile communication network control apparatus receives, from each of a predetermined number of radio base stations 2, a radio propagation time between that radio base station 2 and the mobile station 1 and outputs the received radio propagation times to the mobile station position detection apparatus 4.

The mobile station position detection apparatus 4 receives a predetermined number of radio propagation times output from the mobile communication network control apparatus 3, searches for and acquires pieces of position information of the radio base stations 2 corresponding to these radio propagation times, and obtains the position of the mobile station 1 from these pieces of position information and the predetermined number of radio propagation times received from the mobile communication network control apparatus 3.

Each of the plurality of radio base stations 2 periodically sends a notification signal, i.e., information necessary for the mobile station 1 to do communication in the area covered by the radio base station 2. Upon receiving the position detection instruction signal from the mobile communication network control apparatus 3, each radio base station 2 transmits the position detection instruction signal to the mobile station 1 designated by the signal. On the other hand, upon receiving a position detection signal used for position detection from the mobile station 1 through a reverse common channel, if the received position detection signal is targeted to the radio base station 2, it obtains a radio propagation time from the radio base station 2 to the mobile station 1 on the basis of the sending time of the latest notification signal, the reception time of the received position detection signal, and a predetermined processing time in the mobile station 1 and transmits the radio propagation time to the mobile communication network control apparatus 3.

The mobile station 1 receives the position detection instruction signal from each radio base station 2. Then, the mobile station 1 receives the notification signal sent from each of the plurality of radio base stations 2, extracts a predetermined number of radio base stations 2 in descending order of reception signal power level, and transmits a position detection signal to these radio base stations 2 through corresponding reverse common channels.

The position registration server 5 receives a position registration signal, i.e., a signal with which the mobile station 1 registers its position through the radio base station 2 and mobile communication network control apparatus 3. The position registration server 5 registers a mobile station ID added to the position registration signal, the ID of the radio base station 2 which has relayed the position registration signal from the mobile station 1, and the area code of the area covered by the radio base station 2 and manages the radio base station ID and mobile station ID for each area code. In addition, the position registration server 5 registers and manages for each mobile station ID whether the mobile station 1 is in the communication state.

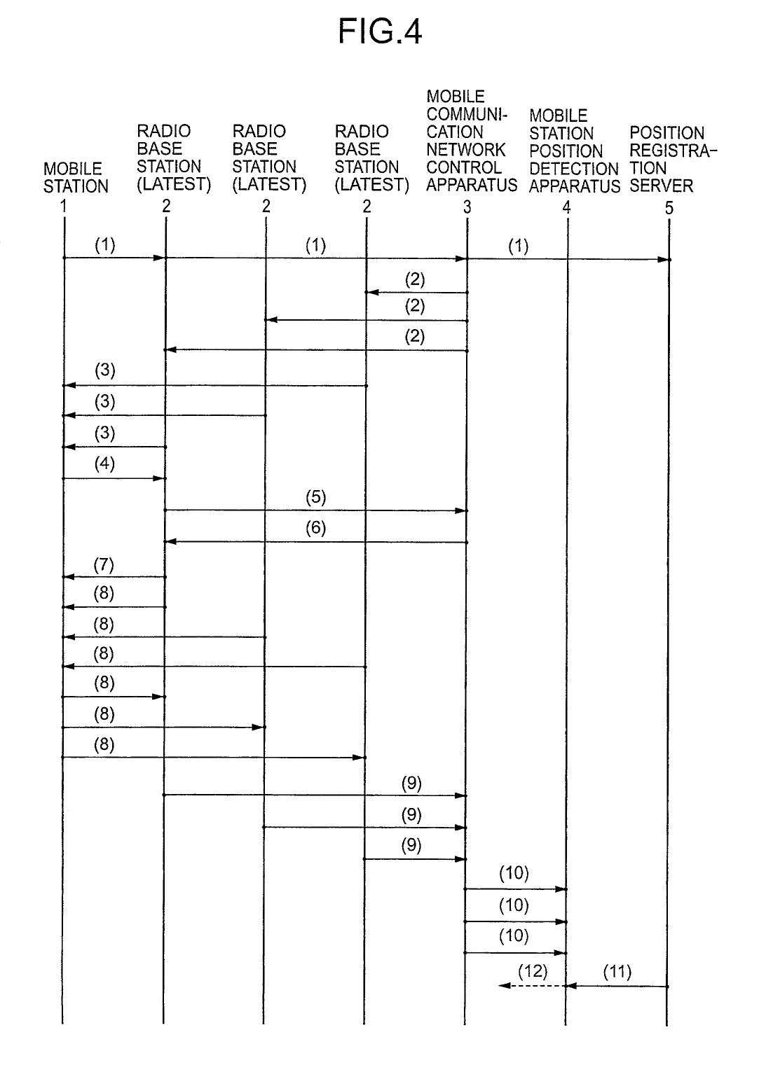

The operation of the mobile station position detection scheme of this embodiment shown in FIG. 3 will be described next in detail with reference to FIGS. 4, 5, and 6.

FIG. 4 is a timing chart for explaining the operation procedure of the mobile station position detection scheme shown in FIG. 3.

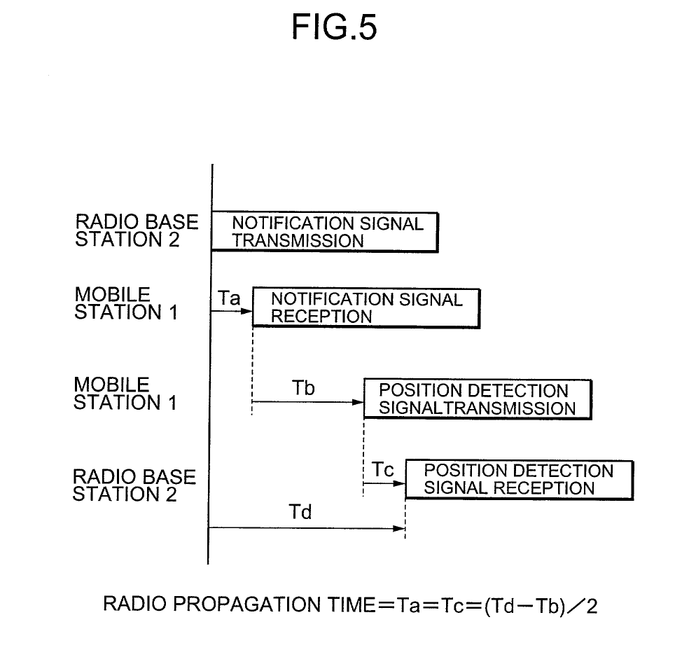

FIG. 5 is a view showing a method of obtaining a radio propagation time between a mobile station and a radio base station.

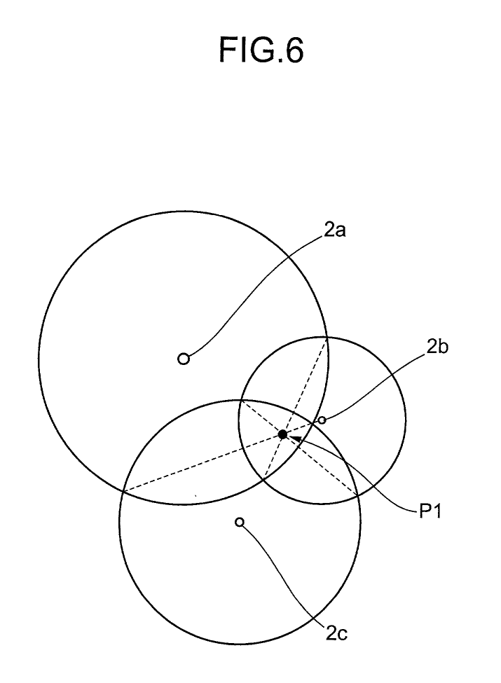

FIG. 6 is a view showing an example in which the position of the mobile station is obtained using three circles.

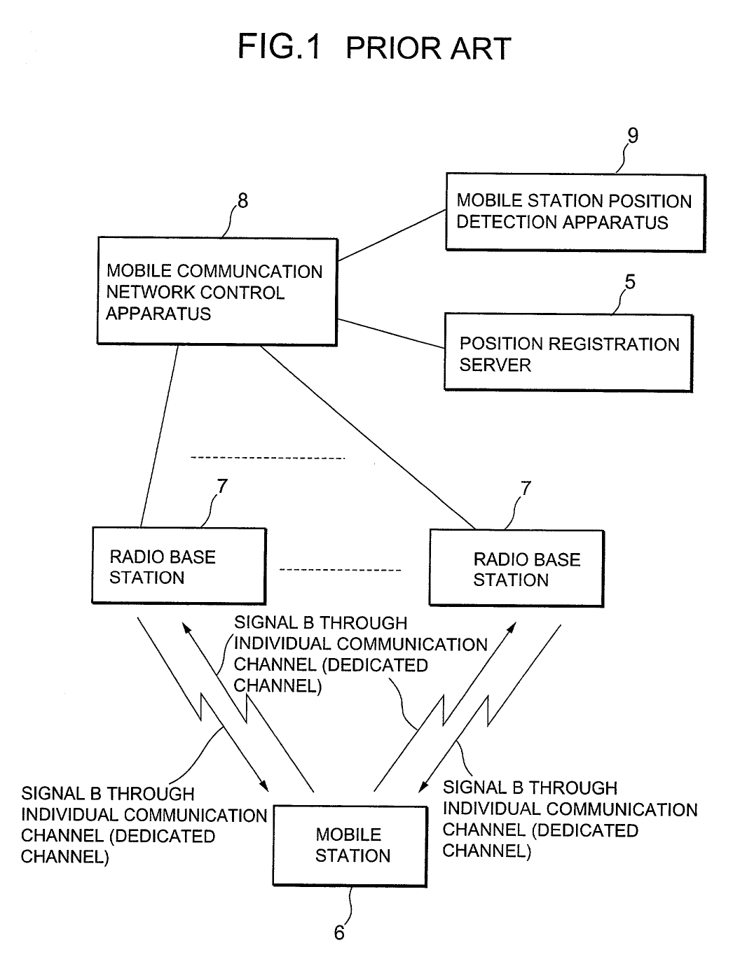

Referring to FIG. 3, as described in the prior art shown in FIG. 1, when a communication state is set between the mobile station 1 and the mobile communication network control apparatus 3, it registers the state of the mobile station 1 as the communication state in the position registration server 5. When the mobile communication network control apparatus 3 and mobile station 1 cease to be in the communication state, the mobile communication network control apparatus 3 cancels the communication state. That is, when a communication state is set between the mobile station 1 and the mobile communication network control apparatus 3, it registers the communication state in the position registration server 5 in correspondence with the mobile station ID to define the state of the mobile station 1 as the communication state. When the mobile communication network control apparatus 3 and mobile station 1 cease to be in the communication state, the mobile communication network control apparatus 3 cancels the communication state registered in correspondence with the mobile station ID to define the state of the mobile station 1 as a non-communication state.

The mobile station position detection scheme of this embodiment shown in FIG. 3 operates in steps (1) to (12) shown in FIG. 4 (to be described below).

(1) When the mobile station 1 is powered on or moves to the area of another radio base station 2, the radio base station 2 closest to the mobile station 1 receives, from the mobile station 1, a position registration signal which registers the position of the mobile station 1, adds to the position registration signal (with the mobile station ID) the ID of the radio base station 2 and the area code of the area covered by the radio base station 2, and sends the signal to the position registration server 5 through the mobile communication network control apparatus 3. The position registration server 5 registers the mobile station ID, radio base station ID, and area code and manages the radio base station ID and mobile station ID for each area code.

(2) The mobile communication network control apparatus 3 receives a position detection request signal (with the ID of the mobile station 1 to be detected) for requesting position detection of the mobile station 1 from a terminal or the like in or outside the mobile communication network and checks by the position registration server 5 whether the state of the mobile station 1 registered in correspondence with the ID of the mobile station 1 is a communication state. If the mobile station 1 is not in a communication state, the mobile communication network control apparatus 3 sends a call signal (with the mobile station ID) for calling the mobile station 1 having the mobile station ID added to the position detection request signal to the radio base stations 2 having radio base station IDs corresponding to the area codes registered in the position registration server 5.

(3) Each radio base station 2 sends a notification signal (with a radio base station ID) to the mobile station 1 located near the radio base station 2 periodically (at an interval of about 1.2 see) using a broadcast channel which is used to notify the mobile station 1 of information necessary for communication in the area covered by the radio base station 2 as a notification signal. Upon receiving the call signal (with the mobile station ID) from the mobile communication network control apparatus 3, the radio base station 2 transmits the call signal to the mobile station 1 having the mobile station ID added to the call signal.

(4) The mobile station 1 receives the call signal from the radio base station 2 and sends a reply signal (with the mobile station ID) to the closest radio base station 2 using a reverse common channel (random access channel).

(5) Upon receiving the reply signal (with the mobile station ID) as a reply to the call signal transmitted in step (3), each radio base station 2 adds its ID to the reply signal and sends the signal to the mobile communication network control apparatus 3.

(6) The mobile communication network control apparatus 3 receives the reply signal to the call signal sent in step (2) and sends a position detection instruction signal (with the mobile station ID) for instructing position detection of the mobile station 1 having the mobile station ID added to the reply signal to the radio base station 2 having the radio base station ID added to the reply signal.

(7) Upon receiving the position detection instruction signal from the mobile communication network control apparatus 3, the radio base station 2 transmits the position detection instruction signal to the mobile station 1 having the mobile station ID added to the position detection instruction signal using a forward common channel (forward access channel).

(8) The mobile station 1 receives the position detection instruction signal from the closest radio base station 2. Then, the mobile station 1 receives a notification signal (with a radio base station ID) sent from each of the plurality of radio base stations 2 and extracts a predetermined number of (at least three) radio base stations 2 (to be referred to as three radio base stations 2 hereinafter) in descending order of reception signal power level. The mobile station 1 transmits a position detection signal (containing one mobile station ID and three radio base station IDs) at a high transmission power to the three extracted radio base stations 2 through reverse common channels (random access channels) corresponding to the radio base stations 2. In other words, the mobile station 1 calculates a propagation attenuation factor by radio propagation of a notification signal on the basis of transmission power indicated by transmission power information contained in the notification signal from each of the three extracted radio base stations 2, i.e., transmission power information when each radio base station 2 has transmitted the notification signal, and reception signal power of each notification signal, which is measured by the mobile station 1. The mobile station 1 transmits the position detection signal to the three extracted radio base stations 2 at a transmission power as a sum of power corresponding to the propagation attenuation factor and a predetermined transmission power necessary for the three extracted radio base stations 2 to receive a signal when no propagation attenuation occurs. The transmission period of the position detection signal transmitted through a random access channel is 10 ms at most. For this reason, the transmission power does not influence other channels by interference or noise.

(9) Each radio base station 2 receives the position detection signal used for position detection through a reverse common channel (random access channel). If the position detection signal contains the ID of the radio base station 2, the radio base station 2 obtains a difference (Td) between the sending time of the latest notification signal and the reception time of the received position detection signal, as shown in FIG. 5. A processing time (Tb) in the mobile station 1 (time between reception of the notification signal and sending of the position detection signal), which is experimentally determined in advance by measurement or the like, is subtracted from the difference, and the result is divided by 2, thereby obtaining a radio propagation time (Ta or Tc) from the radio base station 2 to the mobile station 1. The radio base station 2 adds the mobile station ID and radio base station ID to the obtained radio propagation time and transmits the radio propagation time to the mobile communication network control apparatus 3.

(10) In correspondence with the position detection instruction signal sent in step (6), the mobile communication network control apparatus 3 receives, for each of the three radio base stations 2, the radio propagation time (with the radio base station ID and mobile station ID) between the radio base station 2 and the mobile station 1, and outputs the three radio propagation times.

(11) The mobile station position detection apparatus 4 receives the three radio propagation times from the mobile communication network control apparatus 3, acquires the position information of the radio base stations 2 having the radio base station IDs added to the radio propagation times from a database in which the pieces of position information of the radio base stations 2 are stored in advance, and obtains a position P1 of the mobile station 1 from the position information of the radio base stations 2 and the three radio propagation times received from the mobile communication network control apparatus 3. That is, the mobile station position detection apparatus 4 draws three circles which have their centers at three positions indicated by the position information of the radio base stations 2 corresponding to the three radio propagation times and use, as their radii, distances obtained on the basis of the radio propagation times corresponding to the radio base stations 2 (for example, by multiplying the speed of light), and obtains the position of the mobile station 1 from the intersection relationship between the three circles. For example, as shown in FIG. 6, three different “pairs of circles” of three circles are selected. Three lines which connect the intersections between the pairs of circles are drawn. The intersection between the three lines is defined as the position of the mobile station 1. Alternatively, for example, when intersections between at least two of the three circles come into contact at one point within a predetermined error range (e.g., several meters), the point of contact is defined as the position of the mobile station 1. Then, the position of the mobile station 1 is output to the mobile communication network control apparatus 3.

(12) The mobile communication network control apparatus 3 receives and displays the position of the mobile station 1 output from the mobile station position detection apparatus 4, and sends the position information of the mobile station 1 to a terminal or the like in or outside the mobile communication network, which has requested position detection of the mobile station 1.

What is claimed is:

1. A mobile station position detection scheme for detecting a position of a mobile station on the basis of radio propagation times between said mobile station and a plurality of radio base stations and pieces of position information from said radio base stations, characterized by comprising:
mobile communication network control means for receiving a position detection request signal which requests position detection of said mobile station, when said mobile station is not in a communication state, sending a position detection instruction signal which instructs position detection of said mobile station to radio base stations that cover an area where said mobile station is present, receiving a radio propagation time between said mobile station and each radio base station from each of a predetermined number of radio base stations in correspondence with the position detection instruction signal, and obtaining the position of said mobile station on the basis of the radio propagation times and pieces of position information from said plurality of radio base stations corresponding to the radio propagation times;
said plurality of radio base stations each of which periodically sends a notification signal as information necessary for said mobile station to do communication in the area covered by the radio base station, upon receiving the position detection instruction signal from said mobile communication network control means, transmits the position detection instruction signal to said mobile station designated by the position detection instruction signal, upon receiving a position detection signal used for position detection through a reverse common channel and if the received position detection signal is targeted to the radio base station, obtains the radio propagation time from the radio base station to said mobile station on the basis of a sending time of a latest notification signal, a reception time of the received position detection signal, and a predetermined processing time in said mobile station, and transmits the radio propagation time to said mobile communication network control means; and
said mobile station which receives the position detection instruction signal from each of said radio base stations, after reception, receives the notification signal sent from each of said plurality of radio base stations, extracts said predetermined number of radio base stations in descending order of reception signal power level, and transmits the position detection signal to said radio base stations through corresponding reverse common channels.

2. A scheme according to claim 1, characterized in that said mobile station receives the position detection instruction signal from each of said radio base stations, then receives the notification signal sent from each of said plurality of radio base stations, and extracts at least three radio base stations in descending order of reception signal power level.

3. A scheme according to claim 2, characterized in that said mobile communication network control means draws three circles which have centers at three positions indicated by the position information from said radio base stations corresponding to three of the radio propagation times received from said predetermined number of radio base stations and use, as radii, distances obtained on the basis of the radio propagation times corresponding to said radio base stations, and obtains the position of said mobile station from an intersection relationship between the three circles.

4. A mobile station position detection scheme for detecting a position of a mobile station on the basis of radio propagation times between said mobile station and a plurality of radio base stations and pieces of position information from said radio base stations, characterized by comprising:
a mobile communication network control apparatus which receives a position detection request signal which requests position detection of said mobile station, checks whether said mobile station is in a communication state, when said mobile station is not in the communication state, sends a position detection instruction signal which instructs position detection of said mobile station to radio base stations that cover an area where said mobile station is present, receives a radio propagation time between said mobile station and each radio base station from each of a predetermined number of radio base stations in correspondence with the position detection instruction signal, and outputs the radio propagation times;
a mobile station position detection apparatus which receives the radio propagation times output from said mobile communication network control apparatus, searches for and acquires pieces of position information of said radio base stations corresponding to the radio propagation times, and obtains the position of said mobile station from the pieces of position information and the radio propagation times received from said mobile communication network control apparatus;
said plurality of radio base stations each of which periodically sends a notification signal as information necessary for said mobile station to do communication in the area covered by the radio base station, upon receiving the position detection instruction signal from said mobile communication network control apparatus, transmits the position detection instruction signal to said mobile station designated by the position detection instruction signal, upon receiving a position detection signal used for position detection through a reverse common channel and if the received position detection signal is targeted to the radio base station, obtains the radio propagation time from the radio base station to said mobile station on the basis of a sending time of a latest notification signal, a reception time of the received position detection signal, and a predetermined processing time in said mobile station, and transmits the radio propagation time to said mobile communication network control apparatus; and
said mobile station which receives the position detection instruction signal from each of said radio base stations, after reception, receives the notification signal sent from each of said plurality of radio base stations, extracts said predetermined number of radio base stations in descending order of reception signal power level, and transmits the position detection signal to said radio base stations through corresponding reverse common channels.

5. A scheme according to claim 4, characterized in that
the scheme further comprises a position registration server which registers whether said mobile station is in the communication state, and
said mobile communication network control apparatus receives the position detection request signal which requests position detection of said mobile station and checks by said position registration server whether said mobile station is in the communication state.

6. A mobile station position detection scheme for detecting a position of a mobile station on the basis of radio propagation times between said mobile station and a plurality of radio base stations and pieces of position information from said radio base stations, characterized by comprising:
a position registration server which receives a position registration signal with which the position of said mobile station is registered, registers a mobile station ID added to the position registration signal, an ID of the radio base station which has relayed the position registration signal from said mobile station, and an area code of an area covered by the radio base station, manages the radio base station ID and the mobile station ID for each area code, and registers and manages for each mobile station ID whether said mobile station is in a communication state;
a mobile communication network control apparatus which receives a position detection request signal (with an ID of said mobile station to be detected) which requests position detection of said mobile station, checks by said position registration server whether said mobile station is in the communication state, when said mobile station is not in the communication state, sends a call signal (with the mobile station ID) which calls said mobile station having the mobile station ID added to the position detection request signal to said radio base stations having the radio base station IDs corresponding to area codes registered in said position registration server, receives a reply signal to the call signal, sends a position detection instruction signal (with the mobile station ID) which instructs position detection of said mobile station having the mobile station ID added to the reply signal to each radio base station having the radio base station ID added to the reply signal, receives a radio propagation time (with the radio base station ID and mobile station ID) between said mobile station and each radio base station from each of a predetermined number of radio base stations in correspondence with the sent position detection instruction signal, and outputs the received radio propagation times;
a mobile station position detection apparatus which receives the radio propagation times output from said mobile communication network control apparatus, acquires pieces of position information of said radio base stations having the radio base station IDs added to the radio propagation times from a database in which the pieces of position information of said radio base stations are stored in advance, and obtains the position of said mobile station from the pieces of position information of said radio base stations and the radio propagation times received from said mobile communication network control apparatus;
said plurality of radio base stations each of which periodically sends a notification signal (with the radio base station ID) to said mobile station located near the radio base station using a broadcast channel serving as a channel used to notify said mobile station of information necessary for communication under the radio base station as a notification signal, upon receiving the call signal (with the mobile station ID) from said mobile communication network control apparatus, transmits the call signal to said mobile station having the mobile station ID added to the call signal, upon receiving the reply signal (with the mobile station ID) as a reply to the call signal, adds the ID of the radio base station to the reply signal, sends the reply signal to said mobile communication network control apparatus, upon receiving the position detection instruction signal from said mobile communication network control apparatus, transmits the position detection instruction signal to said mobile station having the mobile station ID added to the position detection instruction signal, upon receiving a position detection signal used for position detection through a reverse common channel and when the position detection signal contains the ID of the radio base station, obtains the radio propagation time from the radio base station to said mobile station on the basis of a sending time of a latest notification signal, a reception time of the received position detection signal, and a predetermined processing time in said mobile station, adds the ID of the radio base station to the obtained radio propagation time, and transmits the radio propagation time to said mobile communication network control apparatus; and
said mobile station which receives the call signal from the radio base station, sends the reply signal (with the mobile station ID) to the closest radio base station using the reverse common channel, after the position detection instruction signal is received from the closest radio base station, receives the notification signal (with the radio base station ID) sent from each of said plurality of radio base stations, extracts said predetermined number of radio base stations in descending order of reception signal power levels, and transmits the position detection signal (containing the mobile station ID and a predetermined number of radio base station IDs) to said radio base stations through corresponding reverse common channels.

7. A scheme according to any one of claims 4, 5, and 6, characterized in that said mobile station receives the position detection instruction signal from each of said radio base stations, then receives the notification signal sent from each of said plurality of radio base stations, and extracts at least three radio base stations in descending order of reception signal power level.

8. A scheme according to claim 7, characterized in that said mobile station position detection apparatus draws three circles which have centers at three positions indicated by the position information from said radio base stations corresponding to three of the radio propagation times received from said mobile communication network control apparatus and use, as radii, distances obtained on the basis of the radio propagation times corresponding to said radio base stations, and obtains the position of said mobile station from an intersection relationship between the three circles.

9. A scheme according to claim 3 or 8, characterized in that when intersections between at least two of the three circles come into contact at one point within a predetermined error range, a point of contact is defined as the position of said mobile station.

10. A scheme according to claim 3 or 8, characterized in that three different pairs of circles of the three circles are selected, three lines which connect intersections between the pairs of circles are drawn, and an intersection between the three lines is defined as the position of said mobile station.

11. A scheme according to any one of claims 1 to 10, characterized in that said radio base station subtracts a predetermined processing time in said mobile station from a difference between the sending time of the latest notification signal and the reception time of the position detection signal and divides a thus obtained time by 2 to obtain the radio propagation time from each of said plurality of radio base stations to said mobile station.

12. A scheme according to claim 11, characterized in that the predetermined processing time is a time between reception of the notification signal and sending of the position detection signal by said mobile station.
